(19) United States
(12) Patent Application Publication
(10) Pub. No.: US 2026/0291319 A1
(43) Pub. Date: Sep. 24, 2026

(54) HOUSING FOR A VEHICLE AND VEHICLE WITH SUCH A HOUSING

(71) Applicant: ZF Friedrichshafen AG, Friedrichshafen (DE)

(72) Inventors: Hermann LANZ, Frickingen (DE); Sylva ROTHER, Kressbronn am Bodensee (DE); Mario HOLDER, Tettnang (DE); Berthold SCHRAFF, Friedrichshafen (DE); Horst LEICHSENRING, Meinheim (DE); Marco HENGGE, Bad Wurzach (DE)

(73) Assignee: ZF Friedrichshafen AG, Friedrichshafen (DE)

(21) Appl. No.: 19/576,644

(22) Filed: Mar. 24, 2026

(30) Foreign Application Priority Data
Mar. 24, 2025 (DE) 10 2025 111 176.6

(51) Int. Cl. H02K 5/04; B60K 6/26; B60K 6/38; B60K 11/02; H02K 7/108; H02K 9/193

(52) U.S. Cl. CPC H02K 5/04; B60K 6/26; B60K 6/38; B60K 11/02; H02K 7/108; H02K 9/193; B60Y 2200/92; B60Y 2306/03; B60Y 2306/05

(57) ABSTRACT

A housing (1) for a vehicle (100) has an outer surface with an inwardly formed recess (2) formed in a portion of the outer surface designated as the bottom side. A device (3) is arranged in the recess (2) on the outer surface and is fluidically connected to an interior of the housing (1). A first protective rib (4) and a second protective rib (5) are arranged in the region of the recess (2) on the outer surface and flank the device (3). The first and second protective ribs (4, 5) project radially outward to protect the device (2). A vehicle (100) can include such a housing (1).

### RELATED APPLICATIONS

This application claims the benefit of and right of priority under 35 U.S.C. § 119 to German Patent Application no. 10 2025 111 176.6, filed on 24 Mar. 2025, the contents of which are incorporated herein by reference in its entirety.

### FIELD OF THE DISCLOSURE

The invention relates to a housing for a vehicle, wherein the housing is specifically designed to accommodate powertrain components and includes an external device.

### BACKGROUND

Housings for vehicles that accommodate, for example, a transmission or a drive unit are generally known. Such a housing thus serves as an enclosure that accommodates devices and components within its interior. If additional devices are arranged outside the housing, additional enclosures are typically provided for the devices outside the housing for protection.

For example, EP 2 577 107 B1 discloses a hybrid drive module with a housing arrangement that accommodates powertrain components in its interior.

### SUMMARY

The task of the present invention is to improve a housing for a vehicle, with a particular focus on optimizing the protection of a device mounted on the exterior of the housing. Furthermore, the housing is designed to be compact. The task is solved by a vehicle housing as variously disclosed herein. Advantageous embodiments will be apparent from the present disclosure, including the following description and the figures.

According to a first aspect, a housing for a vehicle is provided, comprising an outer surface with an inwardly formed recess formed in a portion of the outer surface designated as the bottom side, a device arranged in the recess on the outer surface and fluidically connected to an interior of the housing, a first protective rib and a second protective rib, which are arranged in the region of the recess on the outer surface and flank the device, wherein the two protective ribs project radially outward to protect the device. The term “flank” means that the protective ribs are arranged on two sides of the device, such that the device is spatially positioned between the two protective ribs.

The housing and the device fixedly connected to the outer surface of the housing form a pre-assembled unit. Preferably, the vehicle's powertrain components are arranged inside the housing. For example, a clutch actuator and/or a drive unit—preferably an electric motor with a reduction gearbox—is arranged in the interior of the housing. Furthermore, an internal combustion engine on the input side of the housing and a manual gearbox on the output side of the housing may be connected such that they drive each other via an input shaft and an output shaft, respectively.

The recess on the outer surface of the housing faces inward and is designed, at least in part, to accommodate the device. Consequently, the device extends at least partially into the recess, which is formed as an indentation, thereby providing at least partial protection for the device without taking up a significant amount of space in the interior of the housing.

To further improve the protection of the device, two protective ribs extending radially over the device are arranged in the region of the recess on the outer surface. The two protective ribs flank the device laterally and essentially serve two protective functions: protecting the device from stresses, particularly contact forces, acting on the device when the housing is set down during installation or maintenance, and protecting it from stone chips during vehicle operation. This is because the device is arranged on a bottom side of the housing—that is, an outer surface facing downward toward the road—wherein the radial projection of the protective ribs reliably shields the device. As a result, the housing can be designed to be particularly compact, since it has no protrusion from the device either laterally or upward relative to the vehicle. The housing is particularly suitable for trucks with a frame construction.

In one embodiment, the two protective ribs are essentially parallel and identical in design and extend in the longitudinal direction of the housing. The recess and the device are thus enclosed on two opposite sides, thereby providing not only reliable support surfaces for placing the housing but also lateral protection against stone chips and splashing water.

In one embodiment, the two protective ribs are formed to extend obliquely in the radial direction. In other words, the two protective ribs are ramp-shaped in the longitudinal direction of the housing, thereby allowing the housing to be placed at an angle, with the housing preferably resting on an additional support point when placed. In particular, the device is screwed onto the housing at an angle. The angle of inclination of the device essentially corresponds to the angle of inclination of the ramp-shaped protective ribs. This further improves lateral protection against stone chips and splashing water.

According to one embodiment, a third protective rib is arranged transversely to the two protective ribs and is connected to the two protective ribs. In particular, the three protective ribs form an open enclosure that is open on one of four sides of the device. Consequently, the protective ribs extend along three of the four sides of the device. Preferably, a side of the device facing away from the direction of travel remains open. The formation of three protective ribs on the housing further increases protection against stone chips and splashing water and offers a good compromise for easy installation and maintenance of the device arranged on the outer skin of the housing.

According to one embodiment, the housing has an essentially cylindrical basic shape, with the recess located in the outer surface, which is formed as a shell surface. For example, the housing may be constructed in multiple parts and may be closed off at least on one end face or on both end faces with a respective housing cover.

According to one embodiment, at least one protective plate for covering the device is detachably connected to at least one of the protective ribs, in particular to the first two protective ribs or to all three protective ribs. For example, exactly one protective plate is screwed to the protective ribs at three or four points to ensure a secure hold. The protective plate preferably extends over the entire device and is designed such that the airflow can reliably divert splashing water.

According to one embodiment, the at least one protective plate, together with at least one protective rib, forms a labyrinth seal. For example, a leg of the protective plate extends along a protective rib, thereby forming an air gap whose width and length are dimensioned such that the ingress of dirt and splashing water is impeded or prevented.

According to one embodiment, the device is configured as a fluid pump for supplying lubricant and coolant to the interior of the housing. The fluid pump preferably conveys lubricant and coolant from a sump in the interior of the housing to a clutch actuator, through shafts to bearings and gear areas, and/or to an electric motor to dissipate heat there.

According to a second aspect, a vehicle is provided with a housing according to the first aspect. The above definitions, as well as the descriptions of technical effects, advantages, and advantageous embodiments of the housing according to the invention, apply equally to the vehicle of the invention. The vehicle is preferably designed as a truck.

### BRIEF DESCRIPTION OF THE DRAWINGS

Advantageous embodiments of the invention, which are explained below, are shown in the drawings, wherein identical or similar elements are provided with the same reference numerals. It shows:

FIG. 1: a highly simplified schematic illustration of a vehicle according to the invention with a housing according to the invention,

FIG. 2: a schematic illustration of a rear side of the housing,

FIG. 3: a schematic illustration of a bottom side of the housing,

FIG. 4: a schematic cross-sectional view of the housing and

FIG. 5: a detail of a schematic cross-sectional view of the housing according to a second embodiment.

### DETAILED DESCRIPTION

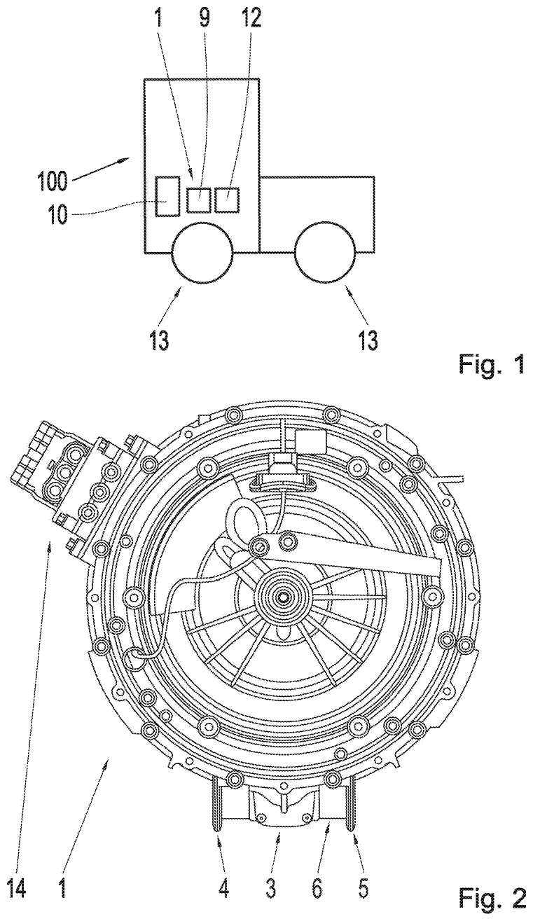

FIG. 1 shows a highly simplified representation of a vehicle 100 configured as a truck. The vehicle 100 comprises a first drive unit configured as an internal combustion engine 10, a second drive unit configured as an electric motor 9, and a manual gearbox 12, which are connected with an actuating effect to the drive wheels 13 of the vehicle 100. Consequently, the truck is configured as a hybrid vehicle. The electric motor 9 is housed in a housing 1, which will be described in more detail below.

FIG. 2 shows the rear side of the housing 1 of FIG. 1. FIG. 2 shows that housing 1 has an essentially cylindrical basic shape and that a device 3 is arranged on a bottom side of the outer surface of housing 1, which is formed as a shell surface. The device 3 is arranged in a recess on the outer surface that is not visible here and is fluidically connected to an interior of the housing 1. In particular, the device 3 is configured as a fluid pump for supplying lubricant and coolant to the interior of the housing 1. The fluid pump primarily delivers lubricant and coolant from a sump in the interior of the housing 1 through shafts to lubricate the bearings and gear sections of a reduction gear, as well as to cool the electric motor located in the rear section of the housing 1. Electrical connections 14 for the electric motor are also arranged on An exterior of housing 1. To protect the device 2, a first protective rib 4, a second protective rib 5, and a third protective rib 6 are arranged on the outer surface in the area of the device 3. The protective ribs 4, 5, 6 flank the device 3 on three sides and thereby protect the device 3 from stone chips and splashing water.

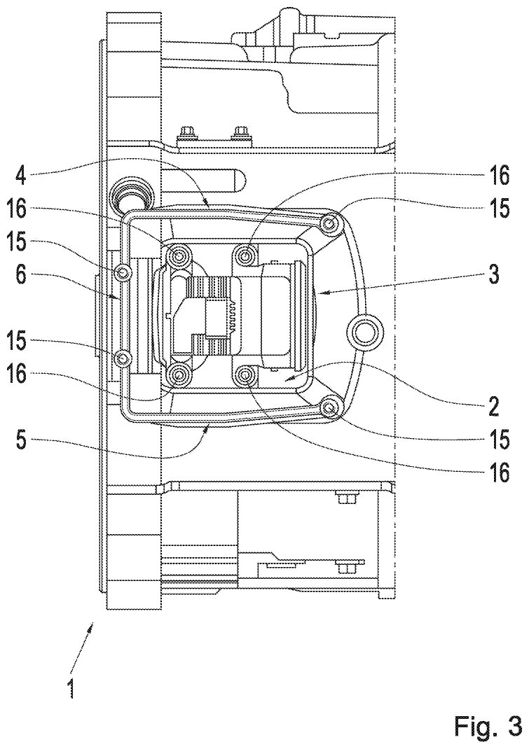

FIG. 3 shows the bottom side of the housing 1 from FIG. 2. FIG. 3 shows that the first and second protective ribs 4, 5 are essentially parallel and identical in design and extend in the longitudinal direction of the housing 1. The third protective rib 6 is arranged transversely to the two protective ribs 4, 5 and is connected to the two protective ribs 4, 5. All three protective ribs 4, 5, 6 flank the recess 2 in which the device 3 is located. The combination of recess 2 and protective ribs 4, 5, 6 on three of the four sides provides a good compromise between sufficient protection against stone chips and splashing water and easy installation and maintenance. Furthermore, this makes the housing 1 particularly compact.

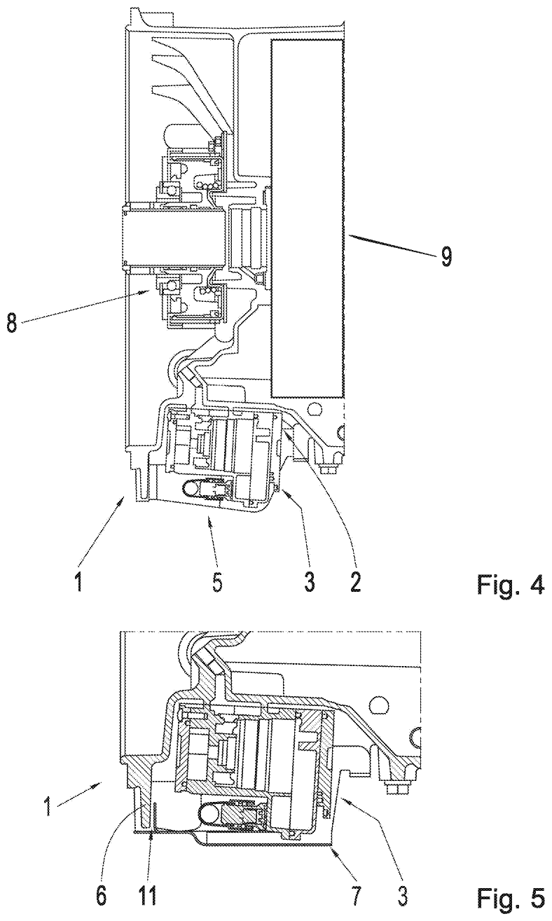

FIG. 4 shows a cross-sectional view of the housing 1 from FIGS. 2 and 3. FIG. 4 shows that the two identically shaped protective ribs-of which only the second protective rib 5 is visible here-are formed to extend obliquely in the radial direction. In other words, the two protective ribs 5 are ramp-shaped in the longitudinal direction of the housing 1, thereby enabling the housing 1 to be placed at an angle. Furthermore, the device 3 is also screwed into the recess 2 on the housing 1 at an angle, with the four screw fasteners 16 provided for this purpose on the device 3 being visible in FIG. 3. The angle of inclination of the device 3 essentially corresponds to the angle of inclination of the ramp-shaped protective ribs 5. This further improves lateral protection against stone chips and splashing water. FIG. 4 further shows that the electric motor 9 is arranged in a rear section of the housing 1, while a clutch actuator 8 is arranged in a front section of the housing 1. The clutch actuator 8 has a hollow-shaft-shaped section for accommodating an input shaft not shown in detail.

FIG. 5 shows a detail of a second embodiment of the housing 1. The second embodiment of the housing 1 essentially corresponds to the first embodiment of the housing 1, the only difference between these two embodiments being that a protective plate 7 is provided to cover the device 3. The protective plate 7 is detachably connected to the housing 1 via four screw fasteners (not shown in detail), which are screwed into threaded holes 15 provided for this purpose on the protective ribs 4, 5, 6, as shown in FIG. 3. In the first embodiment of the housing 1 according to FIG. 3, these threaded holes 15 are also present, and the protective plate 7 according to FIG. 5 can be retrofitted. The protective plate 7 forms a labyrinth seal 11 at least with the third protective rib 6, thereby further improving protection against stone chips and splash water.

### REFERENCE NUMERALS

1 housing
2 recess
3 device
4 first protective rib
5 second protective rib
6 third protective rib
7 protective plate
8 clutch actuator
9 electric motor
10 internal combustion engine
11 labyrinth seal
12 manual gearbox
13 drive wheel
14 connections
15 threaded hole
16 screw fastener

1. A housing (1) for a vehicle (100), comprising:
an outer surface with an inwardly formed recess (2) formed in a portion of the outer surface designated as a bottom side;
a device (3) arranged in the recess (2) on the outer surface and fluidically connected to an interior of the housing (1); and
a first protective rib (4) and a second protective rib (5) arranged in the region of the recess (2) on the outer surface and flanking the device (3), wherein the first and second protective ribs (4, 5) project radially outward to protect the device (2).

2. The housing (1) according to claim 1, wherein the first and second protective ribs (4, 5) are essentially parallel and identical in design and extend in a longitudinal direction of the housing (1).

3. The housing (1) according to claim 1, wherein the first and second protective ribs (4, 5) extend obliquely in a radial direction.

4. The housing (1) according to claim 1, comprising a third protective rib (6) arranged transversely to the first and second protective ribs (4, 5) and connected to the first and second protective ribs (4, 5).

5. The housing (1) according to claim 1 at least one protective plate (7) configured for covering the device (3) and detachably connected to at least one of the first and second protective ribs.

6. The housing (1) according to claim 5, wherein the at least one protective plate (7) forms a labyrinth seal (11) together with at least one of the first and second protective ribs.

7. The housing (1) according to claim 1, wherein the device (3) is configured as a fluid pump for supplying lubricant and coolant to the interior of the housing (1).

8. The housing (1) according to claim 1, comprising a clutch actuator (8) and/or an electric motor (9) arranged in the interior of the housing (1).

9. The housing (1) according to claim 1, wherein the housing (1) has an essentially cylindrical basic shape, and wherein the recess (2) is formed in a shell surface of the housing

10. A vehicle (100) comprising the housing (1) according to claim 1.
